(19) United States
(12) Patent Application Publication
(10) Pub. No.: US 2007/0034526 A1
(43) Pub. Date: Feb. 15, 2007

(54) Electrolytic processing apparatus and method

(76) Inventors: Natsuki Makino, Tokyo (JP); Junji Kunisawa, Tokyo (JP); Keisuke Namiki, Tokyo (JP); Yukio Fukunaga, Tokyo (JP); Katsuyuki Musaka, Tarrytown, NY (US); Ray Fang, Tarrytown, NY (US); Emanuel Israel Cooper, Scarsdale, NY (US); John Michael Cotte, New Fairfield, CT (US); Hariklia Deligianni, Tenafly, NJ (US); Keith T. Kwietniak, Highland Falls, NY (US); Brett C. Baker-O'Neal, Sleepy Hollow, NY (US); Matteo Flotta, Fishkill, NY (US); Philippe Mark Vereecken, Leuven (BE)

Correspondence Address: SQUIRE, SANDERS & DEMPSEY L.L.P., 1 MARITIME PLAZA, SUITE 300, SAN FRANCISCO, CA, 94111, US

(21) Appl. No.: 11/202,684

(22) Filed: Aug. 12, 2005

(51) Int. Cl. B23H 3/00

(52) U.S. Cl. 205/686; 204/212

(57) ABSTRACT

An electrolytic processing apparatus can planarize uniformly over an entire surface of a substrate under a low pressure without any damages to the substrate. The electrolytic processing apparatus has a substrate holder configured to hold and rotate a substrate having a metal film formed on a surface of the substrate and an electrolytic processing unit configured to perform an electrolytic process on the substrate held by the substrate holder. The electrolytic processing unit has a rotatable processing electrode, a polishing pad attached to the rotatable processing electrode, and a pressing mechanism configured to press the polishing pad against the substrate. The electrolytic processing unit also has a liquid supply mechanism configured to supply an electrolytic processing liquid between the substrate and the rotatable processing electrode, a relative movement mechanism operable to move the substrate and the rotatable processing electrode relative to each other, and a power supply configured to applying a voltage between the rotatable processing electrode and the metal film of the substrate so that the rotatable processing electrode serves as a cathode and the metal film of the substrate serves as an anode.

### BACKGROUND OF THE INVENTION

1. Field of the Invention

The present invention relates to an electrolytic processing apparatus and method, and more particularly to an electrolytic processing apparatus and method for removing a conductive material formed on a surface of a substrate such as a semiconductor wafer.

2. Description of the Related Art

In recent years, there has been a growing tendency to replace aluminum or aluminum alloy as a metallic material for forming interconnection circuits on a substrate such as a semiconductor wafer with copper (Cu) having a low electric resistivity and a high electromigration resistance. Copper interconnections are generally formed by filling copper into fine recesses formed in a surface of a substrate. As methods for forming copper interconnections, there have been employed chemical vapor deposition (CVD), sputtering, and plating. In any of the methods, after a copper film is formed on substantially the entire surface of a substrate, unnecessary copper is removed by chemical mechanical polishing (CMP).

FIGS. 1A through 1C show an example of a process of forming a copper interconnection in a substrate W. As shown in FIG. 1A, an insulating film 2, such as an oxide film of SiO₂ or a film of low-k material, is deposited on a conductive layer 1a on a semiconductor base 1 on which semiconductor devices have been formed. A contact hole 3 and an interconnection groove 4 are formed in the insulating film 2 by lithography etching technology. Then, a barrier layer 5 made of TaN or the like is formed on the insulating film 2, and a seed layer 7, which is used as a feeding layer for electrolytic plating, is formed on the barrier layer 5 by sputtering, CVD, or the like.

Subsequently, as shown in FIG. 1B, a surface of the substrate W is plated with copper to fill the contact hole 3 and the interconnection groove 4 with copper and to form a copper film 6 on the insulating film 2. Thereafter, the surface of the substrate W is polished by chemical mechanical polishing (CMP) to remove steps, which have been unintentionally formed on the surface of the substrate W during plating according to interconnection patterns. Further, the copper film 6, the seed layer 7, and the barrier layer 5 are removed from the insulating film 2 so that the surface of the copper film 6 filled in the contact hole 3 and the interconnection groove 4 is made substantially even with the surface of the insulating film 2. Thus, as shown in FIG. 1C, an interconnection comprising the copper film 6 is formed in the insulating layer 2.

Recently, components in various types of equipment have become finer and have required higher accuracy. As submicronic manufacturing technology has commonly been used, the properties of the materials are greatly influenced by the machining method. Under these circumstances, in a conventional mechanical machining method in which a desired portion in a workpiece is physically destroyed and removed from a surface thereof by a tool, a large number of defects may be produced by the machining, thus deteriorating the properties of the workpiece. Particularly, as low-k materials have more commonly been used for insulating films, it becomes more important to perform a machining process under a low mechanical load without deteriorating the properties of materials.

Some processing methods, such as chemical polishing, electrochemical machining, and electrolytic polishing, have been developed in order to solve the above problem. In contrast to the conventional physical machining methods, these methods perform removal processing or the like through a chemical dissolution reaction. Therefore, these methods do not suffer from defects such as formation of an altered layer and dislocation due to plastic deformation, so that processing can be performed without deteriorating the properties of the materials.

For example, a CMP process generally requires considerably complicated operations and controls and a considerably long period of time for the process. Further, since the CMP process employs slurry (polishing abrasives), it is necessary to sufficiently clean a polished substrate. Additionally, large loads are imposed on treatment of slurry and cleaning liquids. Accordingly, it has strongly been desired to eliminate a CMP process or reduce loads of a CMP process. Further, a low-k material, which has a small dielectric constant, is expected to be used as a material for an interlayer dielectric. However, since the low-k material has a low mechanical strength, it cannot stand stresses caused by CMP. Accordingly, there has been desired a process which can planarize a substrate without causing any stresses to the substrate.

In the conventional CMP process, a certain polishing rate (e.g. 500 mm/min) is required in practical use. Accordingly, a polishing pressure should be increased, for example, to about 350 kPa to increase a polishing rate. The polishing rate in the CMP process is determined by the following Preston equation.
RR=kPV
In the above equation, RR represents a polishing rate (m/s), k constant (Pa⁻¹), P a polishing pressure (Pa), and V a relative speed between a substrate and a polishing surface (m/s).

It can be seen from the Preston equation that a polishing pressure P or a relative speed V should be increased during polishing to maintain a certain polishing rate. In such a case, a surface of a substrate becomes likely to be scratched or chemically damaged. Further, dishing or recesses are likely to be produced to cause lean interconnections. Accordingly, the resistance of interconnections is problematically increased, and the reliability of interconnections is lowered by defects of the interconnections. Thus, the CMP process can achieve a planarized film but may cause damage to interconnections.

### SUMMARY OF THE INVENTION

The present invention has been made in view of the above drawbacks. It is, therefore, an object of the present invention to provide an electrolytic processing apparatus and method which can planarize uniformly over an entire surface of a substrate under a low pressure without any damage to the substrate, for example, when interconnections are formed on the substrate by a damascene process.

According to a first aspect of the present invention, there is provided an electrolytic processing apparatus which can planarize uniformly over an entire surface of a substrate under a low pressure without any damages to the substrate. The electrolytic processing apparatus has a substrate holder configured to hold and rotate a substrate having a metal film formed on a surface of the substrate and an electrolytic processing unit configured to perform an electrolytic process on the substrate held by the substrate holder. The electrolytic processing unit has a rotatable processing electrode, a polishing pad attached to the rotatable processing electrode, and a pressing mechanism configured to press the polishing pad against the substrate. The electrolytic processing unit also has a liquid supply mechanism configured to supply an electrolytic processing liquid between the substrate and the rotatable processing electrode, a relative movement mechanism operable to move the substrate and the rotatable processing electrode relative to each other, and a power supply configured to applying a voltage between the rotatable processing electrode and the metal film of the substrate so that the rotatable processing electrode serves as a cathode and the metal film of the substrate serves as an anode.

According to a second aspect of the present invention, there is provided an electrolytic processing method which can planarize uniformly over an entire surface of a substrate under a low pressure without any damages to the substrate. According to the electrolytic processing method, a substrate having a metal film formed on a surface of the substrate is rotated, and a polishing pad attached to a processing electrode is rotated. An electrolytic processing liquid is supplied between the substrate and the processing electrode. A voltage is applied between the processing electrode and the metal film of the substrate so that the processing electrode serves as a cathode and the metal film of the substrate serves as an anode. The polishing pad is pressed against the substrate. The processing electrode is moved relative to the substrate in a radial direction of the substrate.

According to the present invention, an electrolytic processing liquid is supplied between the processing electrode and the substrate. A voltage is applied between the processing electrode and the substrate to perform an electrolytic process. Accordingly, the substrate can be planarized in a state such that mechanical stress to the substrate is suppressed. Further, removal of a passive film such as a metal complex, an oxide, or a hydroxide can continuously be performed alternately by the polishing pad and discharge of the electrolytic processing liquid. Accordingly, the substrate can be planarized uniformly over the entire surface of the substrate under a low pressure with a relatively low voltage, irrespective of patterns of irregularities on the surface of the substrate. For example, an electrolytic process can be performed under a low pressure (e.g. at least 70 kPa) until the vicinity of a barrier layer, and the remaining metal film and barrier layer can be processed under a low pressure at a relatively low processing rate by a conventional CMP apparatus.

The above and other objects, features, and advantages of the present invention will be apparent from the following description when taken in conjunction with the accompanying drawings which illustrate preferred embodiments of the present invention by way of example.

### BRIEF DESCRIPTION OF THE DRAWINGS

FIGS. 1A through 1C are cross-sectional views showing an example of a process of forming an interconnection in a semiconductor device;

FIG. 2 is a plan view showing an electrolytic processing apparatus according to a first embodiment of the present invention;

FIG. 3 is a front view of the electrolytic processing apparatus shown in FIG. 2;

FIG. 4 is a cross-sectional view taken along line IV-IV of FIG. 2;

FIG. 5 is a cross-sectional view showing a main portion of an electrolytic processing unit in the electrolytic processing apparatus shown in FIG. 2;

FIGS. 6A through 6C are perspective views showing examples of a processing electrode and a polishing pad which can be used in the electrolytic processing unit shown in FIG. 5;

FIG. 7 is a perspective view showing an example of a polishing pad which can be used in the electrolytic processing unit shown in FIG. 5;

FIG. 8 is a cross-sectional view taken along line VIII-VIII of FIG. 2;

FIG. 9 is a cross-sectional view showing a cleaning unit when a wafer is loaded into a frame of the electrolytic processing apparatus shown in FIG. 2;

FIGS. 10 and 11 are flowcharts showing a process of the electrolytic processing apparatus shown in FIG. 2;

FIG. 12 is a cross-sectional view showing the electrolytic processing unit when an electrolytic process is performed on the wafer in the electrolytic processing apparatus shown in FIG. 2;

FIG. 13 is a graph showing a distribution of relative movement speeds which are set for each area of the wafer;

FIG. 14 is a cross-sectional view showing the cleaning unit when the wafer is cleaned in the electrolytic processing apparatus shown in FIG. 2;

FIG. 15 is a cross-sectional view showing an electrolytic processing apparatus according to a second embodiment of the present invention;

FIG. 16 is a partial enlarged view of FIG. 15;

FIG. 17 is a cross-sectional view showing a cleaning unit when a wafer is loaded into a frame of the electrolytic processing apparatus shown in FIG. 15;

FIG. 18 is a cross-sectional view showing a variation of a ball contact shown in FIG. 16;

FIG. 19A is a bottom view showing an example in which a plurality of ball contacts shown in FIG. 16 are combined with each other;

FIG. 19B is a front view of FIG. 19A;

FIG. 20 is a cross-sectional view showing a feed contact according to a third embodiment of the present invention;

FIG. 21 is a cross-sectional view showing a feed contact according to a fourth embodiment of the present invention;

FIG. 22 is a cross-sectional view showing a feed contact according to a fifth embodiment of the present invention;

FIG. 23A is a bottom view showing a feed contact according to a sixth embodiment of the present invention;

FIG. 23B is a front view of FIG. 23A;

FIG. 24 is a cross-sectional view showing a feed contact according to a seventh embodiment of the present invention;

FIG. 25 is a graph showing planarization properties when a wafer was polished by an electrolytic processing apparatus according to the present invention;

FIG. 26A is a cross-sectional view showing a step on a wafer which is removed by a conventional electrolytic processing apparatus; and

FIG. 26B is a cross-sectional view showing a step on a wafer which is removed by an electrolytic processing apparatus according to the present invention.

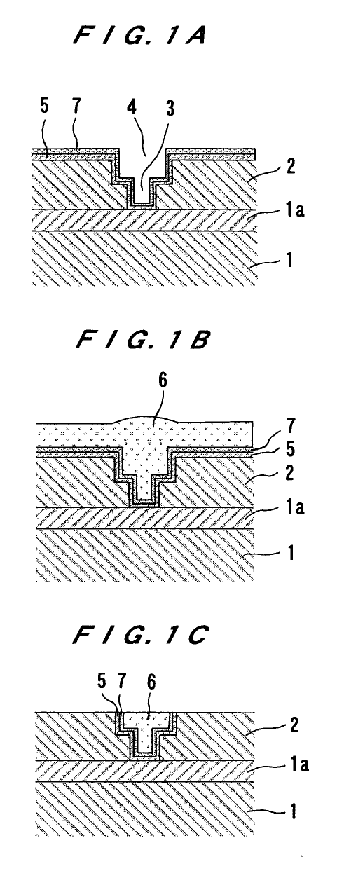

### DETAILED DESCRIPTION OF THE PREFERRED EMBODIMENTS

An electrolytic processing apparatus according to embodiments of the present invention will be described below with reference to the accompanying drawings. Like or corresponding parts are denoted by like or corresponding reference numerals throughout drawings, and will not be described below repetitively.

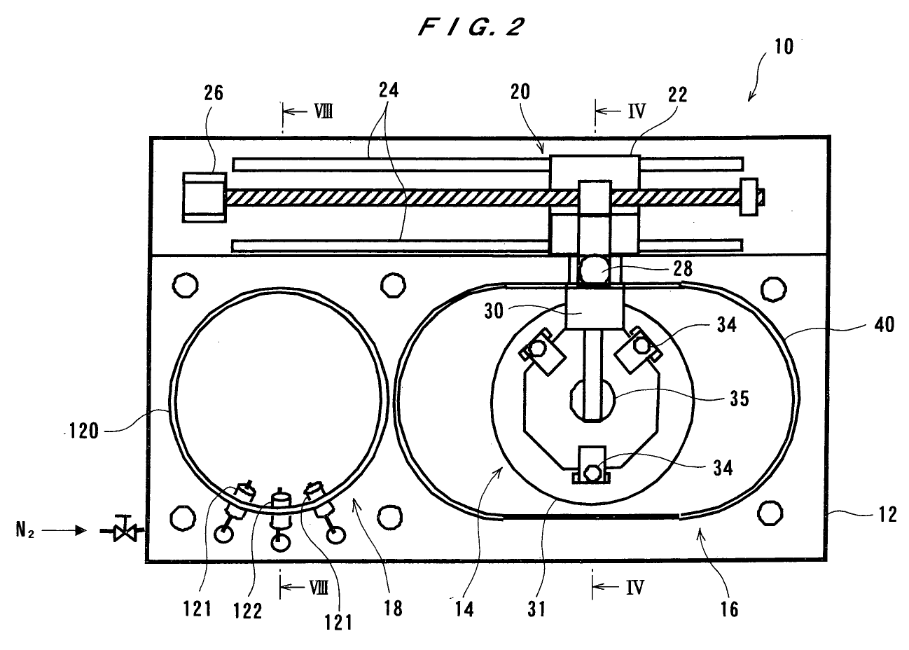

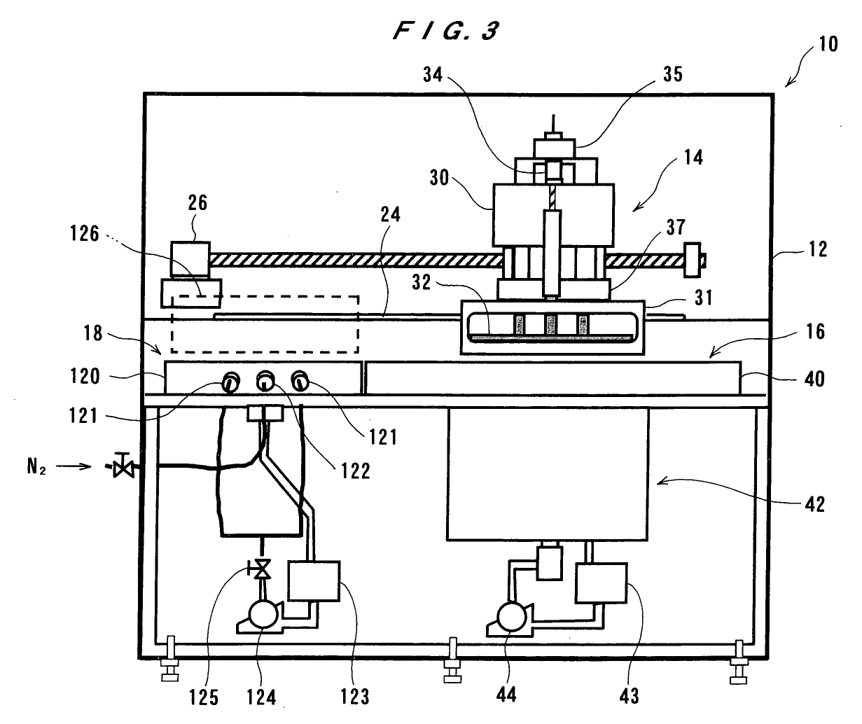

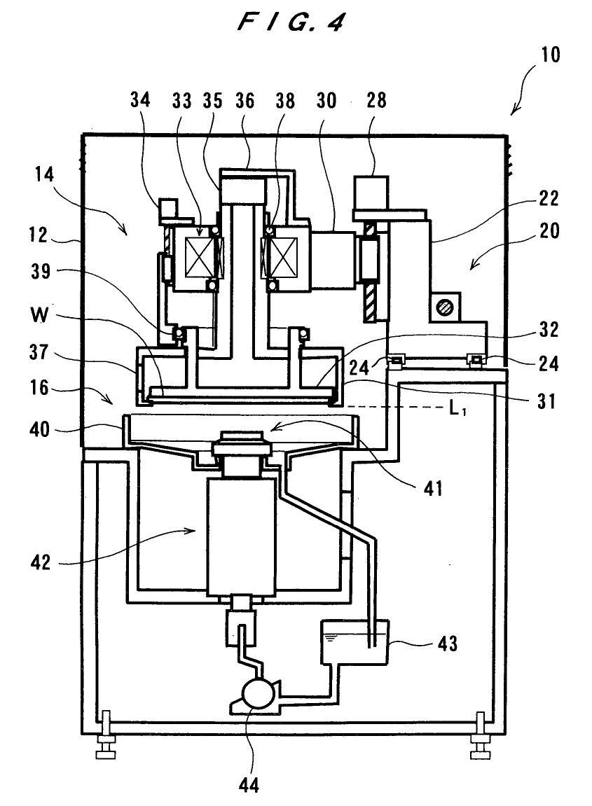

FIG. 2 is a plan view showing an electrolytic processing apparatus 10 according to a first embodiment of the present invention, FIG. 3 is a front view of the electrolytic processing apparatus 10, and FIG. 4 is a cross-sectional view taken along line IV-IV of FIG. 2. As shown in FIGS. 2 through 4, the electrolytic processing apparatus 10 has a frame 12 in a form of a rectangular parallelepiped, a wafer holder 14 for holding a substrate, such as a semiconductor wafer, having a thin metal film formed on a surface of the substrate, an electrolytic processing unit 16 for performing an electrolytic process on the wafer held by the wafer holder 14, a cleaning unit 18 for cleaning the wafer after the electrolytic process, and a carrier 20 for moving the wafer holder 14 between the electrolytic processing unit 16 and the cleaning unit 18. The frame 12 houses the wafer holder 14, the electrolytic processing unit 16, and the cleaning unit 18.

The carrier 20 includes a support block 22 for supporting the wafer holder 14, two linear guides 24 extending along a direction of an array of the electrolytic processing unit 16 and the cleaning unit 18, and a first linear drive unit 26 (horizontal movement mechanism) for moving the support block 22 horizontally along the linear guides 24 by a ball screw mechanism. The support block 22 is attached to the two linear guides 24 so as to be movable in a sliding manner. When the first linear drive unit 26 is driven, the support block 22 is moved between the electrolytic processing unit 16 and the cleaning unit 18.

As shown in FIG. 4, the carrier 20 includes a second linear drive unit 28 (vertical movement mechanism) for moving the wafer holder 14 vertically by a ball screw mechanism. The second linear drive unit 28 is mounted on the support block 22 of the carrier 20. When the second linear drive unit 28 is driven, the wafer holder 14 is moved in a vertical direction.

The wafer holder 14 serves to hold a wafer which is loaded into the frame 12, transfer the wafer, and rotate the wafer during processing. As shown in FIG. 4, the wafer holder 14 has a body 30 which is moved vertically by the second linear drive unit 28 of the carrier 20, a housing 31 supporting a peripheral portion of a wafer W, a backplate 32 which is brought into contact with a rear face of the wafer W, a servomotor 33 having a hollow shaft for rotating the housing 31, a third linear drive unit 34 for vertically moving the backplate 32, a slip ring 35 attached to an upper end of the shaft of the housing 31, and a bracket 36 for supporting the slip ring 35. The housing 31 has an opening 37 formed in a sidewall thereof. The wafer W is introduced and discharged through the opening 37.

The housing 31 is attached to the body 30 via bearings 38. When the servomotor 33 is driven, the housing 31 is rotated. The backplate 32 is coupled to the third linear drive unit 34 via a bearing 39. When the third linear drive unit 34 is driven, the backplate 32, which is rotated together with the housing 31, is moved in a vertical direction.

As shown in FIG. 4, the electrolytic processing unit 16 includes a tray 40 for holding an electrolytic processing liquid (chemical liquid), an electrode head 41 having an processing electrode, a head actuator 42 for moving the electrode head 41 in a vertical direction and rotate the electrode head 41, a polishing liquid tank 43 for reserving the electrolytic processing liquid, and a pump 44 for supplying the electrolytic processing liquid from the polishing liquid tank 43 to the electrode head 41.

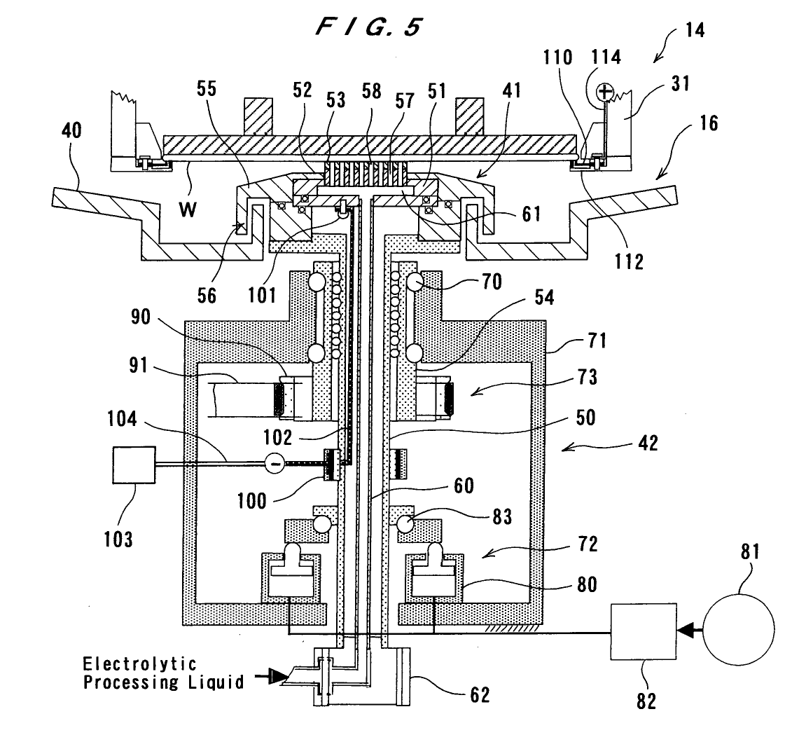

FIG. 5 is a cross-sectional view showing a main portion of the electrolytic processing unit 16. As shown in FIG. 5, the electrode head 41 includes a hollow shaft 50 extending in a vertical direction, an electrode base 51 attached to an upper end of the hollow shaft 50, a circular processing electrode 52 attached to the electrode base 51, and a polishing pad 53 attached to an upper surface of the processing electrode 52. The electrode head 41 also includes a ball spline shaft 54 attached to an outer surface of the hollow shaft 50 and a cover 55 for covering an opening portion of the tray 40. As shown in FIG. 5, a labyrinth 56 is formed between the tray 40 and the cover 55

The processing electrode 52 has a diameter smaller than the diameter of the wafer W. The processing electrode 52 is made of a conductive metal having a corrosion resistance. For example, the processing electrode 52 is made of stainless steel (SUS304). The processing electrode 52 may be subjected to surface treatment such as platinum vapor deposition to improve the durability of the processing electrode 52. The electrode base 51 is also made of a conductive material, e.g. stainless.

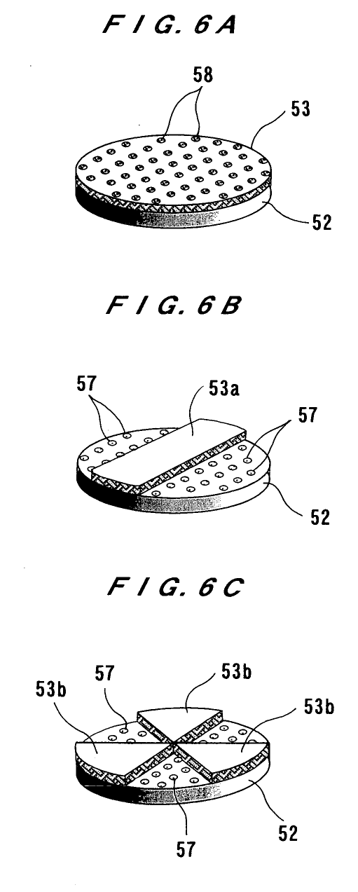

FIG. 6A is perspective view showing the processing electrode 52 and the polishing pad 53 shown in FIG. 5. As shown in FIG. 6A, in the present embodiment, a circular polishing pad 53 is attached to the processing electrode 52 so as to cover an upper surface of the processing electrode 52. For example, the polishing pad 53 is attached to the processing electrode 52 by bonding. For example, the processing electrode 52 has a diameter of about 30 mm. Alternatively, the processing electrode 52 may have a diameter about half the diameter of the wafer W.

As shown in FIGS. 5 and 6A, the processing electrode 52 and the polishing pad 53 have a plurality of through-holes 57 and 58, respectively. As described later, an electrolytic processing liquid (chemical liquid) is supplied through the through-holes 57 and 58 to a surface of the wafer W. For example, the through-holes 57 and 58 have a diameter of 1 mm and a pitch of 4 mm. The diameters and pitches of the through-holes 57 and 58 may have any value as long as the electrolytic processing liquid is supplied to the entire surface of the wafer W Further, in order to promote supply of the electrolytic processing liquid and facilitate discharge of by-products, grooves may be formed in an upper surface of the polishing pad 53 so as to connect the through-holes 58 to each other.

Instead of the polishing pad 53 shown in FIG. 6A, a strip-like polishing pad 53a as shown in FIG. 6B may be attached to the upper surface of the processing electrode 52. Alternatively, as shown in FIG. 6C, a plurality of sectorial polishing pads 53b may be attached to the processing electrode 52. In these cases, the polishing pad may have no through-holes 58. The strip-like polishing pad 53a shown in FIG. 6B can achieve a higher processing rate than the polishing pad 53 shown in FIG. 6A. When the strip-like polishing pad 53a is used, electrolytic processing and removal of a passive film tend to be uneven. When a plurality of sectorial polishing pads 53b shown in FIG. 6C are used, electrolytic processing and removal of a passive film can be made even.

For example, the polishing pad 53 attached to the processing electrode 52 may employ IC1000™ (Rodel Incorporated) or Politex™ (Rodel Incorporated) made of polyurethane. For example, the polishing pad 53 has a thickness of about 1 mm to about 3 mm. In order to bring the polishing pad 53 into uniform contact with the wafer W, an elastic sheet may be interposed between the processing electrode 52 and the polishing pad 53 as needed.

In order to enhance a level of the planarization, a fixed abrasive pad may be used as the polishing pad. The fixed abrasive pad has excellent planarization properties but is disadvantageous in durability because abrasive particles are separated from the fixed abrasive pad during processing.

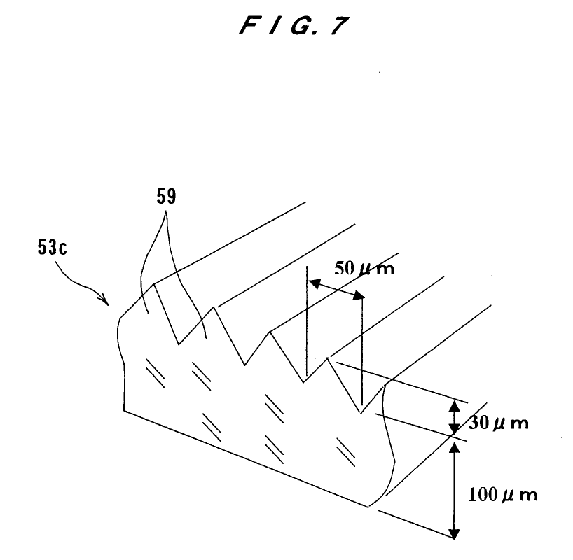

Alternatively, as shown in FIG. 7, the polishing pad may employ a resin pad 53c (serrate pad) having triangular projections 59 formed continuously in the order of several tens of micron. The serrate pad 53c may be made of resin such polyethylene (PE), polypropylene (PP), fluororesin (PTFE), polycarbonate (PC), polyethylene terephthalate (PET), phenolic resin (PF), or epoxy resin (EP). The dimensions are shown in FIG. 7 by way of example and are not limited to the illustrated example.

Referring back to FIG. 5, a polishing liquid supply passage 60 is provided in a hollow portion of the hollow shaft 50. The polishing liquid supply passage 60 supplies an electrolytic processing liquid (chemical liquid) to the surface of the wafer W. The electrode base 51 has a manifold 61 formed therein. The manifold 61 communicates the polishing liquid supply passage 60 to the through-holes 57 and 58 of the processing electrode 52 and the polishing pad 53. The hollow shaft 50 is connected to a rotary connector 62 provided at a lower end of the hollow shaft 50. The polishing liquid supply passage 60 is connected via the rotary connector 62 to the polishing liquid tank 43 shown in FIG. 4. Thus, when the pump 44 is operated, the electrolytic processing liquid in the polishing liquid tank 43 is supplied through the polishing liquid supply passage 60 and the through-holes 57 and 58 of the processing electrode 52 and the polishing pad 53 to the surface of the wafer W.

The through-holes 57 of the processing electrode 52 are provided so as to correspond to the through-holes 58 of polishing pad 53. Portions of the wafer W facing the through-holes 58 of the polishing pad 53 are more likely to be processed than other portions of the wafer W Accordingly, when the through-holes 58 of the polishing pad 53 is so as to be larger than the through-holes 57 of the processing electrode 52, a processing rate is advantageously increased.

As shown in FIG. 5, the head actuator 42 has an actuator frame 71 for supporting the ball spline shaft 54 via bearings 70, a head pressing mechanism 72 for moving the electrode head 41 in a vertical direction to press the polishing pad 53 to the surface of the wafer W, and a head rotation mechanism 73 for rotating the electrode head 41. The hollow shaft 50 is configured so as to be rotatable about its axis and movable in an axial direction with respect to the actuator frame 71 by the ball spline shaft 54.

The head pressing mechanism 72 includes pneumatic pressure actuators 80 for moving the hollow shaft 50 in a vertical direction, a gas supply source 81 for supplying a compressed gas to the pneumatic pressure actuators 80, and a pressure regulator 82 for regulating a pressure of the compressed gas from the gas supply source 81. As shown in FIG. 5, a thrust bearing 83 is attached to the hollow shaft 50. When the thrust bearing 83 is pressed upward by the pneumatic pressure actuators 80, the hollow shaft 50 is moved upward. Thus, the hollow shaft 50 is moved upward to press the polishing pad 53 of the electrode head 41 against the surface of the wafer W under a predetermined force. In the present embodiment, a pressing force of the polishing pad 53 can be controlled directly by the pneumatic pressure actuators 80 and the pressure regulator 82. Accordingly, it is not necessary to provide a load sensor or a displacement sensor. Further, a pressing force can be controlled with high accuracy.

The head rotation mechanism 73 includes a pulley 90 attached to the ball spline shaft 54, a belt 91 connected to the pulley 90, and a motor (not shown) connected to the belt 91. When the motor is driven, the rotation of the motor is transmitted via the belt 91 and the pulley 90 to the ball spline shaft 54 to thereby rotate the hollow shaft 50.

As shown in FIG. 5, a slip ring 100 is attached to the hollow shaft 50. The slip ring 100 connects an electric wire 102 extending from a terminal 101 provided on the electrode base 51 and an electric wire 104 extending from a power supply 103 to each other. Specifically, the processing electrode 52, which is held in contact with the conductive electrode base 51, is connected via the electric wire 102, the slip ring 100, and the electric wire 104 to the power supply 103.

As shown in FIG. 5, the housing 31 of the wafer holder 14 has a comblike feed terminal 110, which is brought into contact with a peripheral portion of the wafer W, and an annular lip seal 112 for sealing the feed terminal 110 from the electrolytic processing liquid. As shown in FIG. 5, the feed terminal 110 has a radially outward portion fixed to the housing 31 and extends radially inward and upward in a cantilevered manner. The feed terminal 110 has radially inward portions which are brought into contact with peripheral portions of the wafer W. The radially inward portions are configured to be resilient so as to maintain a contact pressure. For example, the feed terminal 110 is made of stainless (SUS304) having platinum deposited thereon.

For example, the lip seal 112 is made of fluororubber and brought into contact with a peripheral portion of the wafer W. The feed terminal 110 is disposed at a radially outward position of the lip seal 112 to separate the feed terminal 110 from the electrolytic processing liquid. Thus, the feed terminal 110 is prevented from being brought into contact with the electrolytic processing liquid. An electric wire 114 extends from the feed terminal 110 through a hollow portion of the housing 31 and the slip ring 35 (see FIG. 4) to the power supply 103.

In the present embodiment, a surface of the wafer W on which devices are formed faces downward, whereas the processing electrode 52 and the polishing pad 53 face upward. When the wafer W is processed in a state such that the surface of the wafer W being processed faces upward, the electrolytic processing liquid may be collected in recesses of the surface of the wafer on which the devices are formed. In such a case, processing is carried out mainly at the recesses. As a result, it becomes difficult to control an electrolytic processing rate. On the contrary, the electrolytic processing apparatus 10 in the present embodiment processes the wafer W in a state such that the surface of the wafer W being processed faces downward. Accordingly, unexpected collection of the electrolytic processing liquid can be eliminated on the wafer W. The removal process is preferentially performed on the wafer W only at a portion which is brought into contact with the polishing pad 53 attached to the processing electrode 52. Thus, the electrolytic processing apparatus in the present embodiment can readily achieve a desired removal rate and a desired profile of the wafer W.

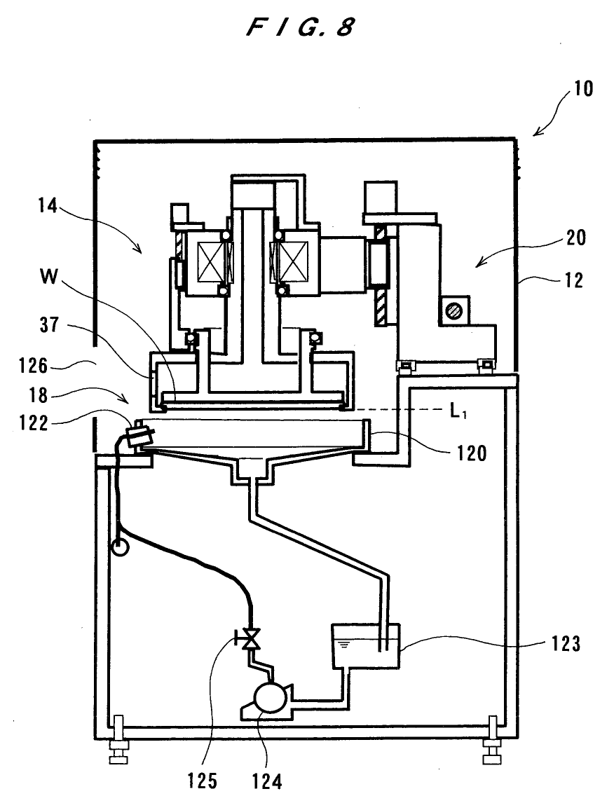

FIG. 8 is a cross-sectional view taken along line VIII-VIII of FIG. 2. As shown in FIGS. 2, 3, and 8, the cleaning unit 18 includes a tray 120 for holding a cleaning liquid, nozzles 121 for ejecting the cleaning liquid toward the wafer W, a nozzle 122 for ejecting a clean gas (e.g. nitrogen gas) toward the wafer W, a cleaning liquid tank 123 for reserving the cleaning liquid, a pump 124 for supplying the cleaning liquid in the cleaning liquid tank 123 to the nozzles 121, and a valve 125 provided between the pump 124 and the nozzles 121. As shown in FIG. 3, the frame 12 has an opening 126 near the cleaning unit 18. The wafer W is introduced and discharged through the opening 126. Although the cleaning liquid is circulated in the example shown in FIG. 8, used cleaning liquid may be discarded if the cleaning liquid is pure water or the like.

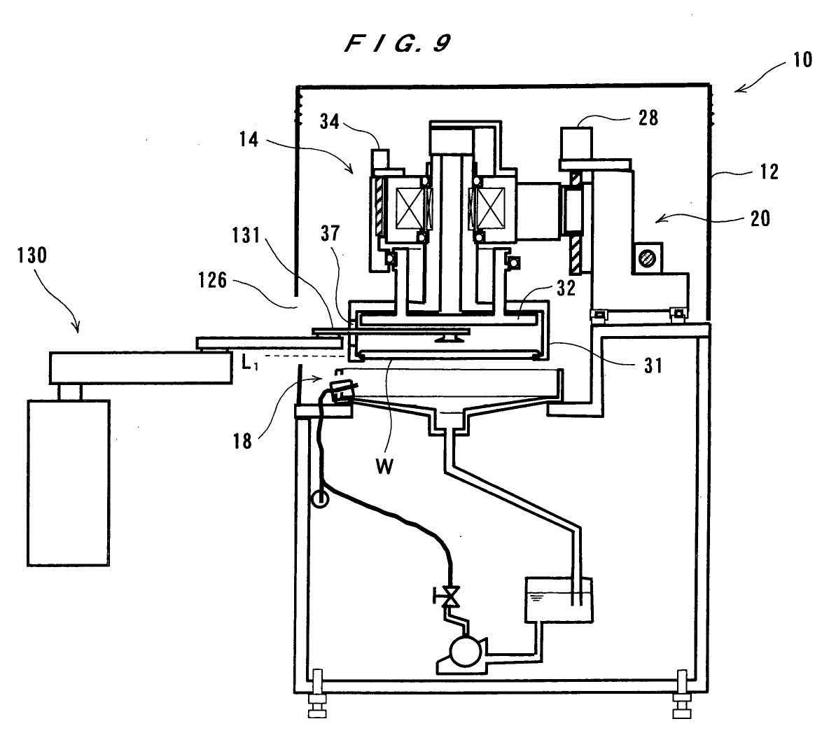

As shown in FIG. 9, the electrolytic processing apparatus 10 has an external robot 130 serving as a loading/unloading section for loading a wafer to be polished into the frame 12 and unloading a polished wafer from the frame 12. When a wafer is loaded or unloaded, the wafer holder 14 is moved above the cleaning unit 18, and the backplate 32 of the wafer holder 14 is set to an upper position.

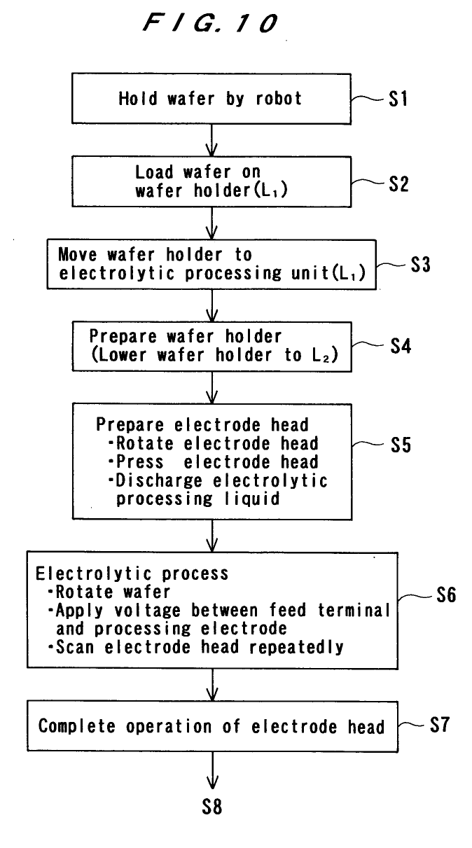

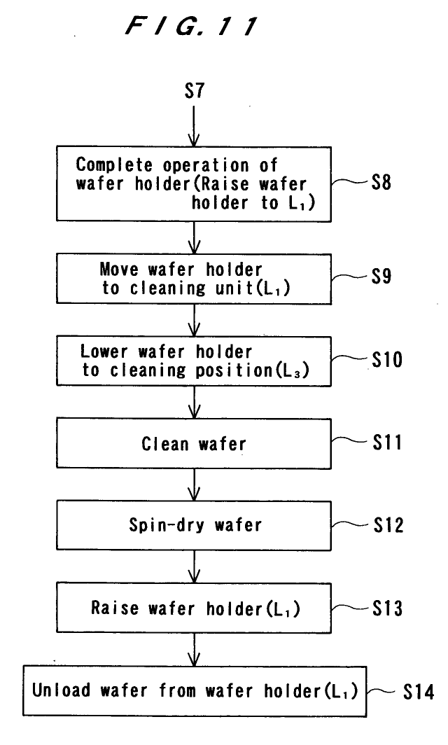

FIGS. 10 and 11 are flowcharts showing a process of the electrolytic processing apparatus 10 in the present embodiment. A wafer to be polished is attracted to a vacuum attraction hand 131 of the external robot 130 and held by the external robot 130 (Step S1). The hand 131 is inserted through the opening 126 of the frame 12 and the opening 37 of the housing 31 into the interior of the housing 31. As shown in FIG. 9, the wafer W is placed on the feed terminal 110 and the lip seal 112 of the housing 31 (see FIG. 5) and loaded on the wafer holder 14 (Step S2). At that time, the wafer is located at a height L₁.

Then, the hand 131 of the external robot 130 is withdrawn from the frame 12. The third linear drive unit 34 is driven to lower the backplate 32 to a predetermined position and to press the wafer W Accordingly, the lip seal 112 of the housing 31 (see FIG. 5) is brought into close contact with a metal film (copper film) formed on a surface of the wafer W at a peripheral portion of the wafer W. Thus, the feed terminal 110 is sealed.

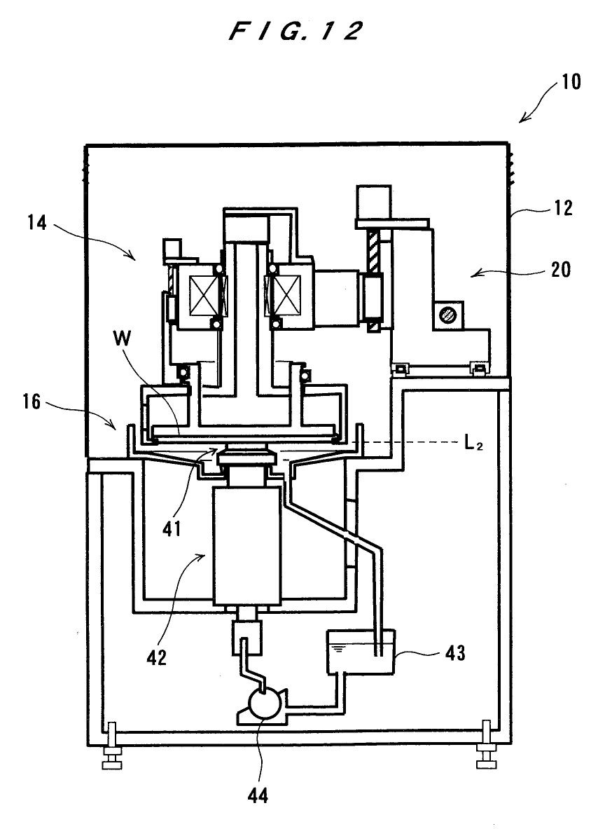

Next, the first linear drive unit 26 of the carrier 20 is driven to move the wafer holder 14 in a horizontal direction at the same height. Thus, the wafer holder 14 is moved to an electrolytic process start position located above the electrolytic processing unit 16 (Step S3). Generally, the electrolytic process start position is set to a position at which a peripheral portion of the wafer faces the processing electrode 52. FIG. 4 shows the wafer holder 14 at that time. Then, the second linear drive unit 28 is driven to lower the wafer holder 14 as shown in FIG. 12. Thus, the wafer holder 14 is brought into contact with or close to the electrode head 41 of the electrolytic processing unit 16 (Step S4). At that time, the wafer is located at a height L₂.

At the time of electrolytic processing, the servomotor 33 of the wafer holder 14 is driven to rotate the housing 31 at a predetermined rotational speed. At the same time, the head actuator 42 of the electrolytic processing unit 16 is operated. Specifically, the head rotation mechanism 73 of the head actuator 42 (see FIG. 5) rotates the electrode head 41 at a predetermined rotational speed. The head pressing mechanism 72 presses the electrode head 41 against a surface of the wafer W under a predetermined force. Then, the pump 44 of the electrolytic processing unit 16 is operated to supply an electrolytic processing liquid from the through-holes 57 and 58 of the processing electrode 52 and the polishing pad 53 to the surface of the wafer W (Step S5). The electrolytic processing liquid ejected from the electrode head 41 is collected in the tray 40. Leakage of the electrolytic processing liquid is prevented by the labyrinth 56 formed between the tray 40 and the rotating electrode head 41. The electrolytic processing liquid collected in the tray 40 is recovered in the polishing liquid tank 43. The recovered electrolytic processing liquid may be reused for a predetermined period of time.

At that time, the power supply 103 applies a predetermined voltage between the processing electrode 52 and the feed terminal 110 so that the processing electrode 52 serves as a cathode and the feed terminal 110 serves as an anode. Thus, the electrolytic process is performed on the surface of the wafer (Step S6). The electrolytic process is performed for a predetermined period of time to remove a metal film on the surface of the wafer for planarization.

During the electrolytic process, the wafer holder 14 may be moved relative to the processing electrode 52. For example, the wafer holder 14 may be reciprocated along a radial direction extending through substantially a center of the wafer in the tray 40 of the electrolytic processing unit 16 by a predetermined distance. The distance of the relative movement is not more than a value obtained by subtracting an outside diameter of the processing electrode 52 from an inside diameter of the lip seal 112.

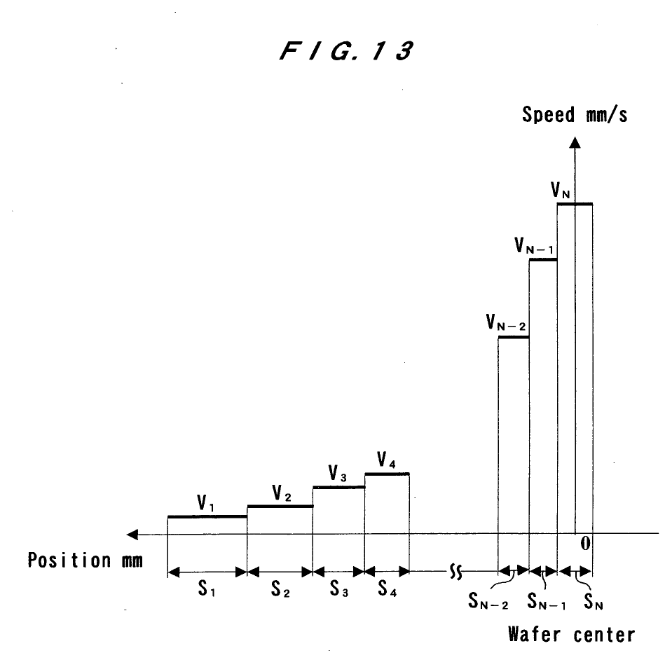

Further, the wafer W may be divided into a plurality of areas in a radial direction of the wafer W The wafer W and the processing electrode 52 may be moved relative to each other at relative movement speeds which are set for each of the divided areas in the wafer W Specifically, the movement speed of the wafer holder 14 may be changed according to positions of the wafer facing the processing electrode 52 so that the relative movement speeds of the processing electrode 52 to the wafer form a predetermined distribution within the surface of the wafer. For example, the relative movement speeds may be changed so as to achieve a distribution shown in FIG. 13. In the example shown in FIG. 13, when the processing electrode 52 faces an area S₁ of the surface of the wafer, the speed of the wafer holder 14 is set at V₁. When the processing electrode 52 faces an area S₂ of the surface of the wafer, the speed of the wafer holder 14 is set at V₂. Areas SN and speeds V_{N} of the wafer holder 14 are optimized according to shapes of the processing electrode 52 and the polishing pad 53, sizes of the processing electrode 52 and the wafer, rotational speeds of the processing electrode 52 and the wafer W, and the like. Thus, it is possible to control a profile of a polished wafer so as to meet requirements for a subsequent process. For example, when the relative movement speed is larger than a predetermined value at a peripheral portion of the wafer W, the amount of removal can be reduced at the peripheral portion of the wafer W. Such a polishing process is suitable for a wafer having a profile in which a peripheral portion of the wafer is relatively thicker than other portions of the wafer.

Further, it is desirable to set a relative movement speed for each area of the wafer W so that all areas of the wafer W have substantially the same total period of time during which the processing electrode 52 faces the area of the wafer W. Furthermore, it is desirable to start and finish the relative movement from an area for which the smallest relative movement speed is set because mechanical loads can be reduced at the time of start and stop of the electrolytic processing unit. Such an area is generally an outermost area of a wafer.

When the electrolytic process is finished, the application of the voltage between the processing electrode 52 and the feed terminal 110 is interrupted. The head rotation mechanism 73 of the head actuator 42 is stopped so as to stop the rotation of the electrode head 41. The pressure of the compresses gas to be supplied to the pneumatic pressure actuators 80 of the head pressing mechanism 72 is adjusted to lower and separate the electrode head 41 from the surface of the wafer (Step S7). The servomotor 33 of the wafer holder 14 is stopped so as to stop the rotation of the housing 31.

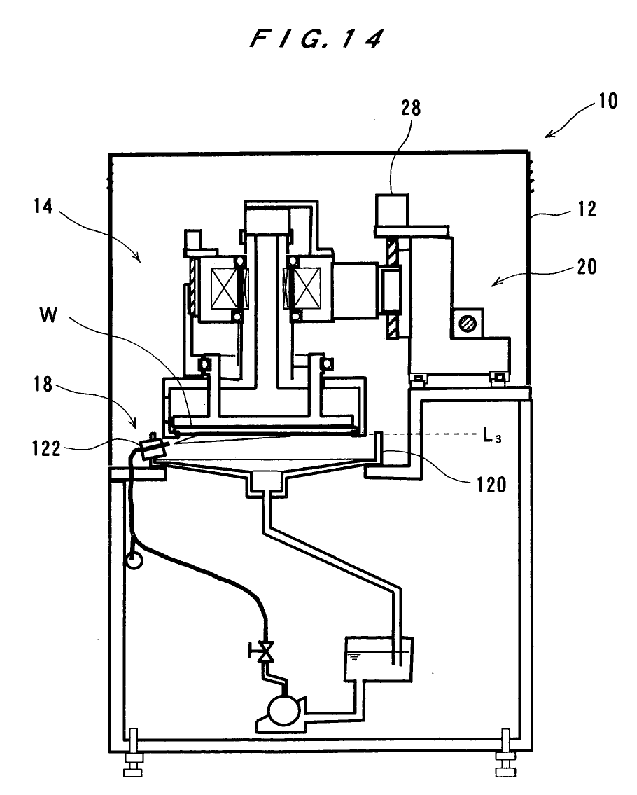

Then, the second linear drive unit 28 of the wafer holder 14 is driven to raise the wafer holder 14 until the wafer W is located at the height L₁ shown in FIG. 4 (Step S8). The first linear drive unit 26 of the carrier 20 is driven to move the wafer holder 14 horizontally to a position above a center of the cleaning unit 18 (Step S9). FIG. 8 shows the wafer holder 14 at that time. Then, the second linear drive unit 28 is driven to lower the wafer holder 14 as shown in FIG. 14 (Step S10). At that time, the wafer is located at a height L₃, which is smaller than L₁ but larger than L₂.

At the time of cleaning, the servomotor 33 of the wafer holder 14 is driven to rotate the housing 31 at a relatively low speed. At the same time, a cleaning liquid (e.g. pure water) is ejected from the nozzles 121 toward the surface of the rotating wafer W (Step S11). Thus, in the present embodiment, the wafer is moved to the cleaning unit 18 immediately after the electrolytic process in the electrolytic processing unit 16. Accordingly, the electrolytic processing liquid attached to the surface of the wafer can immediately be removed to recover a clean surface of the wafer.

After a predetermined period of time, the ejection of the cleaning liquid is stopped. The wafer W is rotated at a high rotational speed by the servomotor 33 of the wafer holder 14 to spin-dry the wafer (Step S12). Then, the wafer W may be rotated at a low rotational speed, and a clean gas (e.g. nitrogen gas) may be ejected from the nozzle 122 to the surface of the wafer W to promote drying of the wafer W. Thus, the cleaning unit 18 in the present embodiment is configured as a spin rinse dry unit (SRD). Accordingly, a clean wafer can be obtained after processing.

After the cleaning process, the second linear drive unit 28 of the wafer holder 14 is driven to raise the wafer holder 14 until the wafer W is located at the height L₁ shown in FIG. 8 (Step S13). Then, the third linear drive unit 34 is driven to raise the backplate 32. As shown in FIG. 9, the hand 131 of the external robot 130 is inserted into the frame 12. The polished wafer W is attracted to the hand 131 and unloaded from the frame 12 (Step S14).

For example, when the electrolytic processing liquid is supplied at a low flow rate, a metal (copper) removed by the electrolytic process may move to the processing electrode 52 and deposited thereon. In such a case, after the electrolytic process, a reverse voltage may be applied to the processing electrode 52 so that the processing electrode 52 serves as an anode. Thus, the metal deposited on the processing electrode 52 can be removed by electrolytic etching.

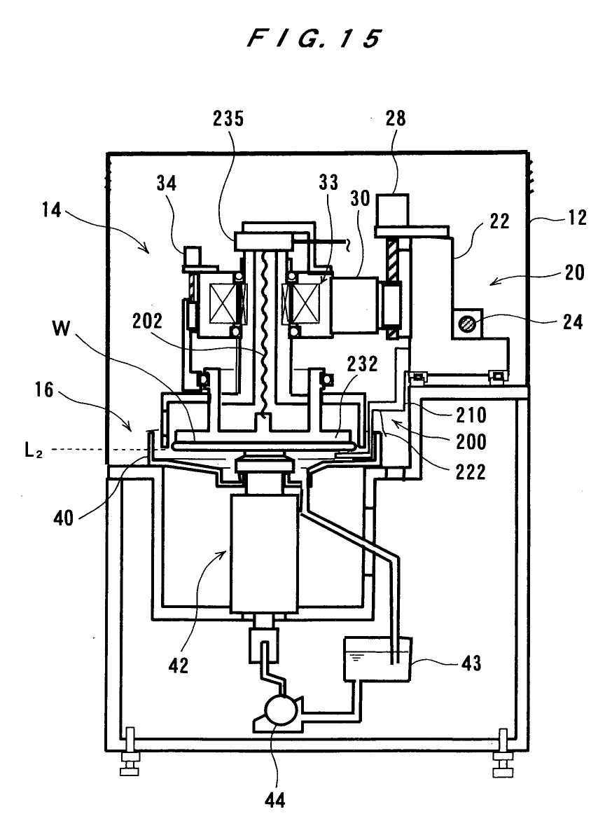

FIG. 15 is a cross-sectional view showing a main portion of an electrolytic processing unit 16 according to a second embodiment of the present invention. In the first embodiment, the housing 31 of the wafer holder 14 has the feed terminal 110 and the lip seal 112 to supply an electric current to the wafer W In the second embodiment, an electric current is supplied to the wafer W through a ball contact 200 mounted on the support block 22 instead of the feed terminal 110 and the lip seal 112 of the wafer holder 14.

In the present embodiment, the backplate 232 of the wafer holder 14 has a vacuum attraction mechanism for attracting a rear face of the wafer W As shown in FIG. 15, a vacuum rotary joint 235 is provided at an upper end of a shaft of the housing 31 in the wafer holder 14 instead of the slip ring 35 shown in FIG. 4. A tube 202 extending from the vacuum attraction mechanism of the backplate 232 is connected through the vacuum rotary joint 235 to a vacuum pump (not shown).

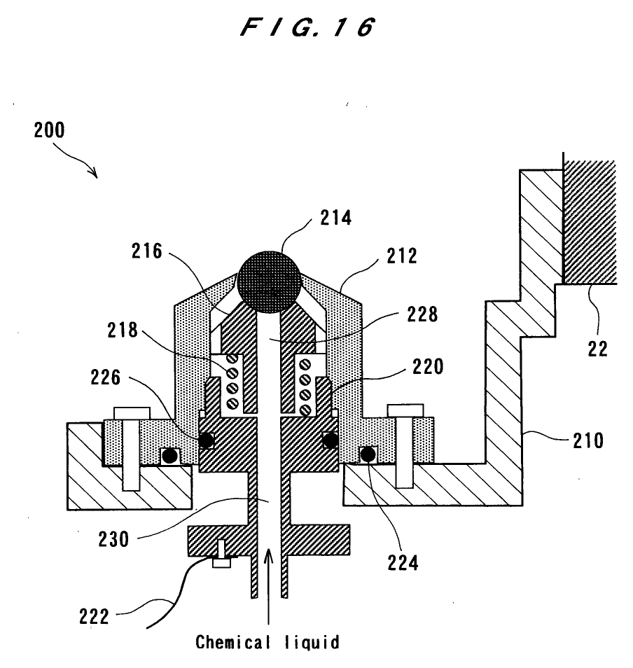

FIG. 16 is a partial enlarged view of FIG. 15. As shown in FIG. 16, the ball contact 200 includes a bracket 210 attached to the support block 22, a case 212 attached to the bracket 21, a ball 214 housed in the case 212 so that a portion of the ball 214 is exposed from a top of the case 212, a rod 216 disposed below the ball 214, a spring 218 for biasing the ball 214 and the rod 216 in an upward direction, and a holder 220 for holding the ball 214, the rod 216, and the spring 218 in the case 212. The portion of the ball 214 exposed from the case 212 is brought into contact with a peripheral portion of the wafer W attracted to the backplate 232 (at a position which does not interfere with the processing electrode 52).

For example, the ball 214 is made of a conductive material such as graphite. When the ball 214 is made of graphite, which is soft and conductive, the surface of the wafer W is prevented from being scratched by the ball 214. Each of the rod 216 and the holder 220 is made of a conductive material. The holder 220 is connected through an electric wire 222 to the power supply 103 (see FIG. 5). Thus, an electric current can be supplied through the holder 220, the rod 216, and the ball 214 to a metal film (copper film) on the surface of the wafer W at a peripheral portion of the wafer W The ball contact 200 can facilitate uniform processing over the entire surface of the wafer W as compared to a dry seal contact, which comprises the feed terminal 110 and the lip seal 112.

The ball contact 200 has a seal 224 disposed between a lower surface of the case 212 and an upper surface of the bracket 210, and a seal 226 disposed between an outer surface of the holder 220 and an inner surface of the case 212. Electrolyte passages 228 and 230 extend vertically through a central portion of the rod 216 and a central portion of the holder 220, respectively. Thus, an electrolyte is supplied through the electrolyte passages 230 and 228 to a surface of the ball 214. Further, an electrolyte is also supplied between the rod 216 and an inner surface of the case 212. Since an electrolyte is thus supplied to the surface of the ball 214, it is possible to increase an effective area of the ball 214 which is electrically connected to the power supply 103. Accordingly, stable current feed can be maintained.

Preferably, an electrolyte to be supplied to the surface of the ball 214 is the same kind of liquid as the electrolytic processing liquid. When the same kind of liquid as the electrolytic processing liquid is supplied to the surface of the ball 214, it is possible to prevent the surface of the wafer W from being contaminated by chemical liquid and improve the reliability of electric connection of the ball 214 to the wafer W Further, the apparatus can be simplified.

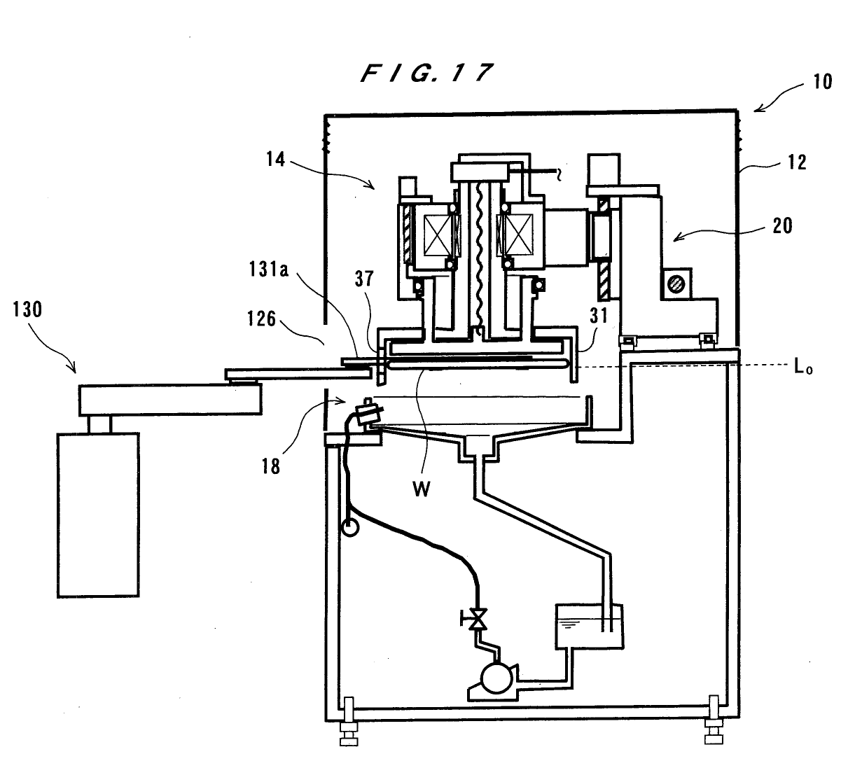

As shown in FIG. 17, in the present embodiment, the external robot 130 has a hand 131a capable of holding a peripheral portion of the wafer W. The hand 131a, which holds a peripheral portion of the wafer W to be polished, is inserted through the opening 126 of the frame 12 and the opening 37 of the housing 31 into the interior of the housing 31. Then, the wafer W is attracted to a lower surface of the backplate 232 under vacuum. At that time, the wafer W is located at a height L₀, which is larger than L₁ in FIG. 9.

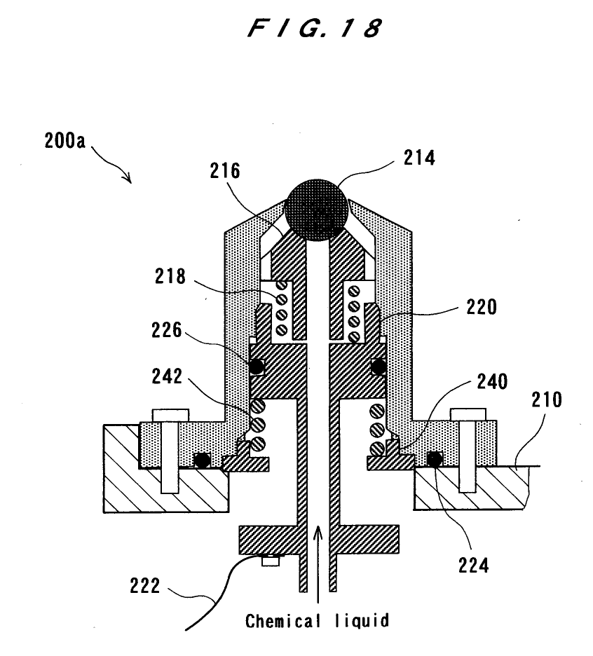

FIG. 18 is a cross-sectional view showing a variation 200a of the ball contact shown in FIG. 16. The ball contact 200 shown in FIG. 16 can have a simple structure but has difficulty in adjusting a pressing force of the ball 214. Accordingly, as shown in FIG. 18, a base 240 is disposed below the holder 220, and an additional spring 242 is disposed between the base 240 and the holder 220. With such an arrangement, a stroke and a pressing force of the ball 214 can be adjusted so as to achieve a practical ball contact.

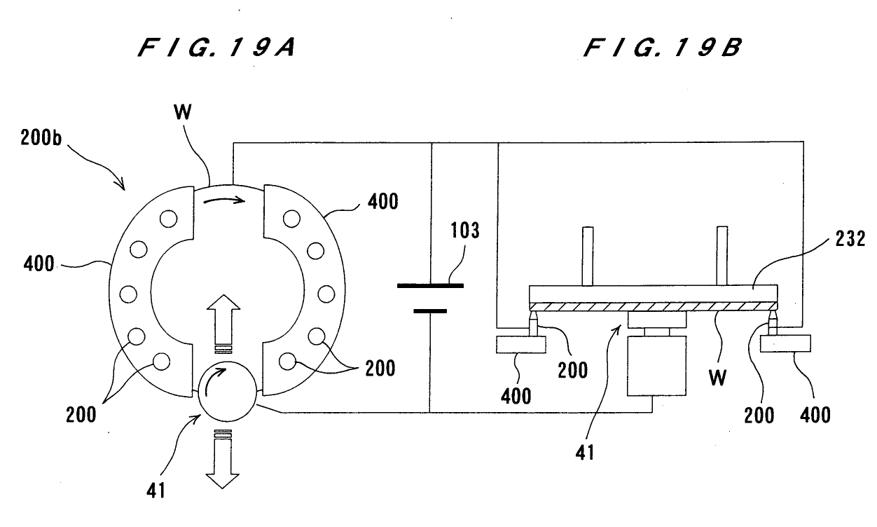

FIGS. 19A and 19B are schematic views showing an example in which a plurality of ball contacts 200 shown in FIG. 16 are combined with each other. FIG. 19A is a bottom view, and FIG. 19B is a front view. As shown in FIGS. 19A and 19B, a contact mechanism 200b includes two retainers 400 each holding a plurality of ball contacts 200. The electrode head 41 is moved between the two retainers 400. The retainers 400 are mounted on the support block 22. In this example, the electrode head 41 and the retainers 400 should not be arranged so that the electrode head 41 and the retainers 400 interfere with each other when the electrode head 41 is moved in a radial direction of the wafer W during the electrolytic process. Thus, the use of a plurality of ball contacts 200 can ensure electric feed to the wafer W. Specifically, when partial removal of a copper film from the surface of the wafer starts, some lands of the copper film may remain on the surface of the wafer. In such a case, it becomes difficult to feed an electric current to the copper film. However, by providing a plurality of ball contacts 200 as shown in FIGS. 19A and 19B, the reliability of electric feed can be improved.

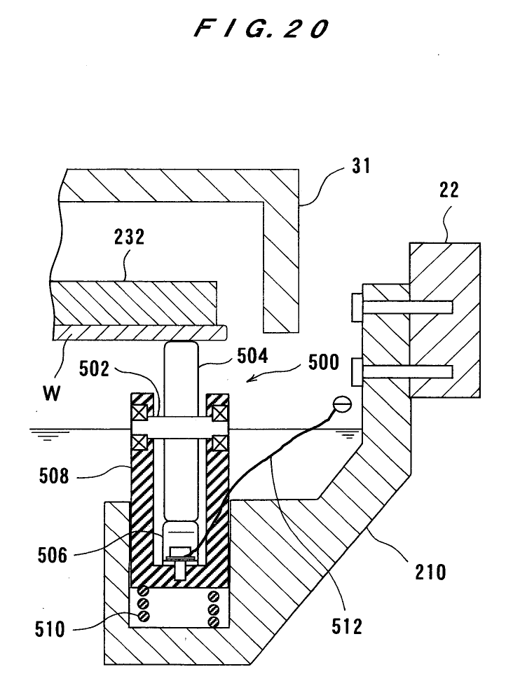

FIG. 20 is a cross-sectional view showing a vertical roller contact 500 which can be used to feed an electric current to the wafer W As shown in FIG. 20, the roller contact 500 includes a rotatable roller 504 about a shaft 502, which is perpendicular to the rotation axis of the wafer W, a feed electrode 506 which is brought into sliding contact with a lower portion of the roller 504, a holder 508 housing the roller 504 and the feed electrode 506, and a spring 510 for biasing the holder 508 in an upward direction. An upper portion of the roller 504 is brought into contact with a peripheral portion of the wafer W attracted to the backplate 232.

The roller 504 has a surface made of a conductive material. The feed electrode 506 has a feed terminal connected to the power supply 103 (see FIG. 5) by an electric wire 512. Thus, an electric current can be fed to a metal film (copper film) formed on the surface of the wafer W via conductive surfaces of the feed electrode 506 and the roller 504. The roller contact 500 having such an arrangement can readily maintain a contact area with the wafer W as compared to the aforementioned ball contact 200. Specifically, while the ball contact 200 is brought into point contact with the wafer W, the roller contact 500 is brought into line contact with the wafer W. Accordingly, the reliability of electric feed can be improved.

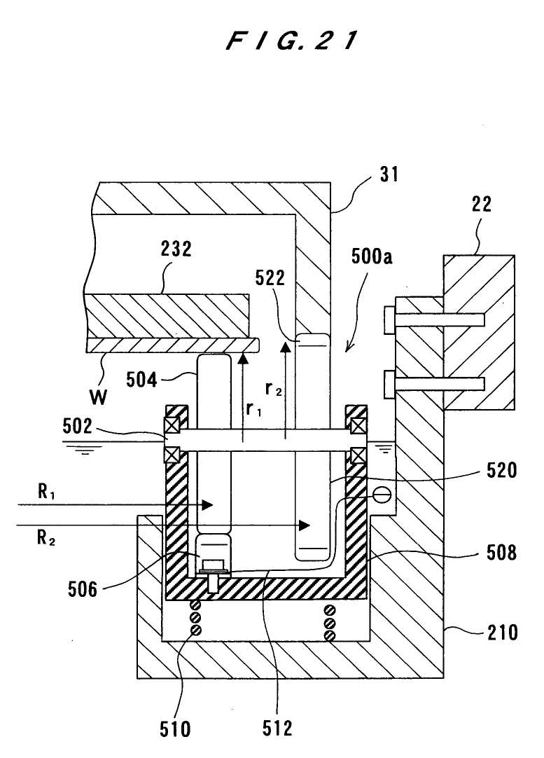

FIG. 21 is a cross-sectional view showing a variation 500a of the roller contact shown in FIG. 20. As shown in FIG. 21, the roller contact 500a includes a gear 520 in addition to the arrangement shown in FIG. 20. The gear 520 serves as a rotation synchronization mechanism for rotating the roller 504 in synchronism with the rotation of the housing 31. The gear 520 has teeth 522 engaging with teeth provided on a lower surface of the housing 31. Thus, the gear 520 is rotated according to the rotation of the housing 31.

The required relationship is defined by
r₁/r₂=R₁/R₂
where r₁ is the radius of the roller 504, r₂ the radius of the gear 520, R₁ a distance between the center of the wafer W and the roller 504, and R₂ a distance between the center of the wafer W and the gear 520. When the gear 520 is rotated, the roller 504 is also rotated in synchronism with the gear 520. Accordingly, it is possible to prevent sliding of the roller 504 on the surface of the wafer W. Thus, the roller 504 is brought into rolling contact with the surface of the wafer W, so that damage to the wafer W can be reduced.

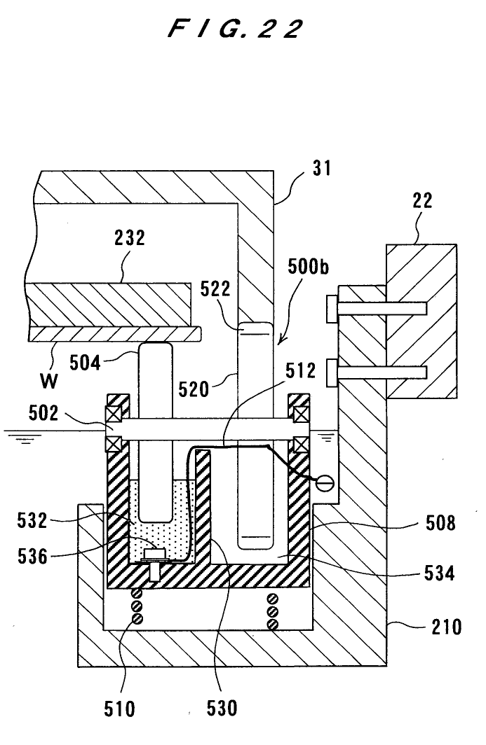

FIG. 22 is a cross-sectional view showing a variation 500b of the roller contact shown in FIG. 21. As shown in FIG. 22, the holder 508 of the roller contact 500b is divided into a roller chamber 532 and a gear chamber 534 by a partition wall 530. The roller contact 500b shown in FIG. 22 does not include the feed electrode 506 which is brought into contact with the roller 504. An electrolyte is filled in the roller chamber 532 between the feed terminal 536, which is connected to the electric wire 512, and the roller 504. Accordingly, an electric current is fed to the roller 504 via the electrolyte. Thus, since there is no feed electrode 506 which is brought into contact with the roller 504, it is possible to eliminate damage to the roller 504 due to contact of the feed electrode 506. Further, the electrolyte is continuously supplied to a contact surface between the wafer W and the roller 504 according to the rotation of the roller 504. Accordingly, the reliability of electric feed can further be improved by providing a wet rolling contact surface.

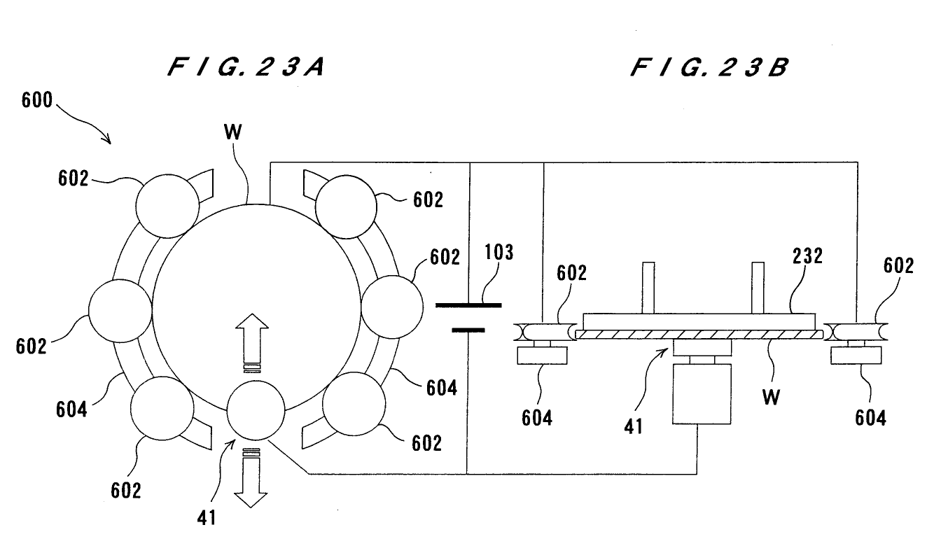

FIGS. 23A and 23B are schematic views showing a horizontal roller contact 600 which can be used to feed an electric current to the wafer W. FIG. 23A is a bottom view, and FIG. 23B is a front view. As shown in FIGS. 23A and 23B, the roller contact 600 includes a roller 602 which is brought into contact with a metal film formed on a surface of a peripheral portion (bevel portion) of the wafer W, and two retainers 604 each holding a plurality of rollers 602. Each of the rollers 602 has a surface made of a conductive material. The roller 602 is connected to the power supply 103. The roller 602 is rotatable about a shaft parallel to the rotation axis of the wafer W. The roller 602 has a side surface which is brought into contact with the peripheral portion of the wafer. The roller 602 is biased in an upward direction by a spring (not shown). With such an arrangement, an electric current can be fed to the metal film formed on the bevel portion of the wafer without direct contact to interconnections of the wafer W. Accordingly, it is possible to eliminate damage to the interconnections of the wafer W and improve the reliability of the interconnections.

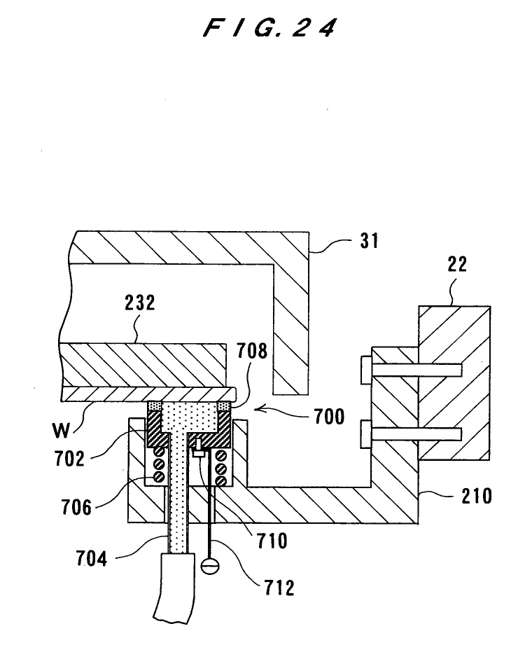

FIG. 24 is a cross-sectional view showing an electrolyte contact 700 which can be used to feed an electric current to the wafer W. As shown in FIG. 24, the electrolyte contact 700 includes a holder 702 for holding an electrolyte therein, an electrolyte supply pipe 704 for supplying the electrolyte to the holder 702, a spring 706 for biasing the holder 702 in an upward direction, and a resilient pad 708 attached to an upper end of the holder 702 for forming an electrolyte pool in the holder 702. The resilient pad 708 is formed by sponge-like material, which is considerably soft, and is thus unlikely to cause damage to the wafer W when the resilient pad 708 is brought into contact with the wafer W.

The holder 702 is made of a conductive material. The holder 702 has a feed terminal 710 mounted thereon. The feed terminal 710 is connected to the power supply 103 (see FIG. 5) by an electric wire 712. Thus, an electric current is fed to the wafer W via the electrolyte held by the holder 702. Thus, since an electric current is fed to the wafer W via the electrolyte, it is not necessary to bring a solid material into contact with the wafer W Accordingly, the reliability of interconnections of the wafer can be improved.

In the examples shown in FIGS. 15 through 24, the feed contact gets wet with an electrolytic processing liquid. However, the surface of the wafer including a peripheral portion of the wafer can be processed uniformly because no seal is required at the peripheral portion of the wafer. During the electrolytic process, the wafer holder 14 may be moved relative to the processing electrode 52. For example, the wafer holder 14 may be reciprocated along a radial direction extending through substantially a center of the wafer in the tray 40 of the electrolytic processing unit 16 by a predetermined distance. The distance of the relative movement is preferably at least the sum of the diameter of the wafer and the diameter of the processing electrode 52.

In the above embodiments, the wafer is processed in a state such that a surface of the wafer faces downward. However, in the embodiments other than the roller contact 500b shown in FIG. 22, the wafer may be processed in a state such that a surface of the wafer faces upward.

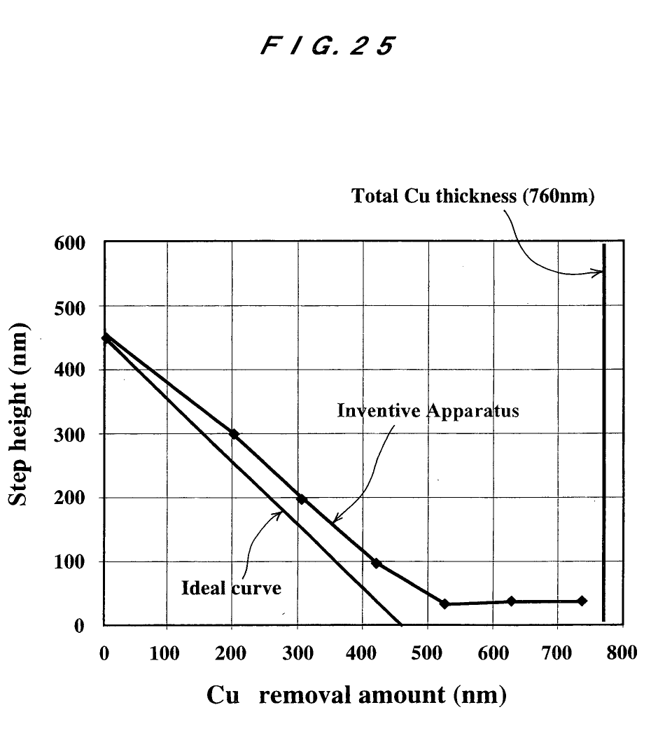

FIG. 25 is a graph showing planarization properties when a wafer was subjected to an electrolytic process with an electrolytic processing apparatus according to the present invention. It can be seen from FIG. 25 that the electrolytic processing apparatus according to the present invention could remarkably improve the planarization properties as compared to a conventional electrolytic processing apparatus. The electrolytic processing apparatus according to the present invention could achieve planarization properties close to ideal properties even though the wafer was processed under a low pressure. The experiment was conducted under the following conditions.
Electrolytic processing liquid: HEDP (1-hydroxyethylidene-diphosphonic acid)+NH₄OH+BTA (benzotriazole)
Diameter of wafer: 200 mm
Diameter of processing electrode: 30 mm
Rotational speed of wafer: 200 rpm
Rotational speed of processing electrode: 75 rpm
Polishing pad: strip-like fixed abrasive pad
Flow rate of electrolytic processing liquid discharged: 200 ml/min
Pressing force of processing electrode: 1 psi. (about 70 kPa)
Applied voltage: 2.25 V (CV)

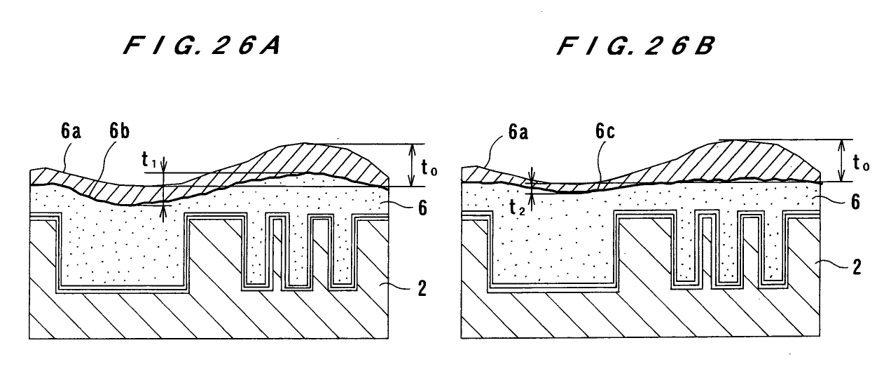

FIG. 26A is a schematic view showing a relationship between an initial step t₀ on a surface 6a of a copper film 6 before a polishing process and a halfway step t₁ on a surface 6b of the copper film 6 during the polishing process with a conventional electrolytic processing apparatus. FIG. 26B is a schematic view showing a relationship between the initial step t₀ on the surface 6a of the copper film 6 before the polishing process and a halfway step t₂ on a surface 6c of the copper film 6 during the polishing process with an electrolytic processing apparatus according to the present invention. It can be seen from FIGS. 26A and 26B that the electrolytic processing apparatus according to the present invention can remarkably reduce the halfway step on the surface of the copper film 6 during the polishing process.

Although high-concentration phosphoric acid solution or a mixture of HEDP and NMI (N-methylimidazole) may be used as the electrolytic processing liquid, the planarization properties of these chemical liquids are slightly lower than those of the electrolytic processing liquid used in the experiment.

Although certain preferred embodiments of the present invention have been shown and described in detail, it should be understood that various changes and modifications may be made therein without departing from the scope of the appended claims.

What is claimed is:

1. An electrolytic processing apparatus comprising:
a substrate holder configured to hold and rotate a substrate having a metal film formed on a surface of the substrate; and
an electrolytic processing unit configured to perform an electrolytic process on the substrate held by said substrate holder, said electrolytic processing unit comprising:
a rotatable processing electrode;
a polishing pad attached to said rotatable processing electrode;
a pressing mechanism configured to press said polishing pad against the substrate;
a liquid supply mechanism configured to supply an electrolytic processing liquid between the substrate and said rotatable processing electrode;
a relative movement mechanism operable to move the substrate and said rotatable processing electrode relative to each other; and
a power supply configured to applying a voltage between said rotatable processing electrode and the metal film of the substrate so that said rotatable processing electrode serves as a cathode and the metal film of the substrate serves as an anode.

2. The electrolytic processing apparatus as recited in claim 1, wherein said rotatable processing electrode has a diameter smaller than a diameter of the substrate.

3. The electrolytic processing apparatus as recited in claim 1, wherein said liquid supply mechanism comprises at least one through-hole formed in said rotatable processing electrode and said polishing pad for allowing the electrolytic processing liquid to pass therethrough.

4. The electrolytic processing apparatus as recited in claim 3, wherein said electrolytic processing unit further comprises a hollow shaft having an upper end to which said rotatable processing electrode is attached,
wherein said liquid supply mechanism further comprises a liquid supply passage formed in a hollow portion of said hollow shaft for supplying the electrolytic processing liquid to said at least one through-hole.

5. The electrolytic processing apparatus as recited in claim 1, wherein said electrolytic processing unit further comprises a hollow shaft having an upper end to which said rotatable processing electrode is attached,
wherein said pressing mechanism comprises a pneumatic pressure actuator operable to press said hollow shaft in an axial direction.

6. The electrolytic processing apparatus as recited in claim 1, wherein said polishing pad comprises a fixed abrasive pad.

7. The electrolytic processing apparatus as recited in claim 1, wherein said polishing pad comprises a resin pad having projections formed continuously on a surface of said resin pad.

8. The electrolytic processing apparatus as recited in claim 1, further comprising:
a loading/unloading section configured to load and unload the substrate; and
a carrier configured to move the substrate between said loading/unloading section and said electrolytic processing unit.

9. The electrolytic processing apparatus as recited in claim 8, wherein said carrier comprises:
a support block configured to support said substrate holder;
a horizontal movement mechanism operable to move said support block in a horizontal direction; and
a vertical movement mechanism operable to move said substrate holder in a vertical direction.

10. The electrolytic processing apparatus as recited in claim 8, further comprising a cleaning unit configured to clean the substrate.

11. The electrolytic processing apparatus as recited in claim 10, wherein said cleaning unit comprises a nozzle configured to eject at least one of a cleaning liquid and a clean gas toward the substrate.

12. The electrolytic processing apparatus as recited in claim 1, wherein said substrate holder comprises:
a housing;
a feed terminal provided on said housing, said feed terminal being brought into contact with a peripheral portion of the substrate;
a seal disposed at a radially inward position of said feed terminal;
a plate operable to press the substrate placed on said feed terminal and said seal against said housing; and
an electric wire connecting said feed terminal to said power supply.

13. The electrolytic processing apparatus as recited in claim 1, wherein said substrate holder comprises a plate operable to attract the substrate to a surface of said plate,
wherein said electrolytic processing unit comprises:
a feed contact which can feed an electric current to a peripheral portion of the substrate attracted to said plate; and
an electric wire connecting said feed contact to said power supply.

14. The electrolytic processing apparatus as recited in claim 13, wherein said feed contact comprises:
a conductive ball which can be brought into contact with the peripheral portion of the substrate;
a rod configured to support said conductive ball;
a spring configured to bias said rod;
a case housing said conductive ball so that a portion of said conductive ball is exposed from a top of said case; and
a holder holding said conductive ball, said rod, and said spring.

15. The electrolytic processing apparatus as recited in claim 14, wherein each of said rod and said holder has a passage for supplying an electrolyte to said conductive ball.

16. The electrolytic processing apparatus as recited in claim 15, wherein the electrolyte is the same kind of liquid as the electrolytic processing liquid.

17. The electrolytic processing apparatus as recited in claim 14, wherein said conductive ball is made of graphite.

18. The electrolytic processing apparatus as recited in claim 13, wherein said feed contact comprises:
a roller having a conductive surface which can be brought into contact with the peripheral portion of the substrate, said roller being rotatable about a shaft perpendicular to a rotation axis of the substrate;
a holder configured to support said roller; and
a feed terminal which can be brought into contact with said conductive surface of said roller, said feed terminal being housed in said holder.

19. The electrolytic processing apparatus as recited in claim 18, wherein said feed contact further comprises a synchronization mechanism operable to synchronize rotation of said roller and rotation of the substrate.

20. The electrolytic processing apparatus as recited in claim 13, wherein said feed contact comprises:
a roller having a conductive surface which can be brought into contact with the peripheral portion of the substrate, said roller being rotatable about a shaft perpendicular to a rotation axis of the substrate;
a holder configured to support said roller and hold an electrolyte therein; and
a feed terminal configured to feed an electric current to said conductive surface of said roller via the electrolyte held in said holder.

21. The electrolytic processing apparatus as recited in claim 13, wherein said feed contact comprises:
a roller having a conductive surface which can be brought into contact with a bevel portion of the substrate, said roller being rotatable about a shaft parallel to a rotation axis of the substrate; and
a retainer operable to press said roller against the bevel portion of the substrate.

22. The electrolytic processing apparatus as recited in claim 13, wherein said feed contact comprises:
a feed terminal connected to said power supply;
a holder configured to hold an electrolyte between the metal film of the substrate and said feed terminal; and
a liquid supply pipe configured to supply the electrolyte to said holder.

23. The electrolytic processing apparatus as recited in claim 22, wherein said feed terminal further comprises a resilient pad which can be brought into contact with the substrate.

24. An electrolytic processing method comprising:
rotating a substrate having a metal film formed on a surface of the substrate;
rotating a polishing pad attached to a processing electrode;
supplying an electrolytic processing liquid between the substrate and the processing electrode;
applying a voltage between the processing electrode and the metal film of the substrate so that the processing electrode serves as a cathode and the metal film of the substrate serves as an anode;
pressing the polishing pad against the substrate; and
moving the processing electrode relative to the substrate in a radial direction of the substrate.

25. The electrolytic processing method as recited in claim 24, wherein said moving comprises moving the processing electrode relative to the substrate by at least a sum of a diameter of the substrate and a diameter of the processing electrode.

26. The electrolytic processing method as recited in claim 24, wherein said moving comprises moving the processing electrode while fixing the substrate.

27. The electrolytic processing method as recited in claim 24, wherein said moving comprises moving the processing electrode and the substrate relative to each other at relative movement speeds which are set for each of areas in the substrate, said areas being divided in a radial direction of the substrate.

28. The electrolytic processing method as recited in claim 27, wherein the relative movement speeds are set at each area of the substrate so that each area of the substrate has substantially the same total period of time during which the processing electrode faces the area of the substrate.

29. The electrolytic processing method as recited in claim 27, wherein said moving comprises starting relative movement at an area for which the smallest relative movement speed is set.

30. The electrolytic processing method as recited in claim 27, wherein said moving comprises finishing relative movement at an area for which the smallest relative movement speed is set.

31. The electrolytic processing method as recited in claim 24, further comprising applying a voltage between the processing electrode and the metal film of the substrate so that the processing electrode serves as an anode and the metal film of the substrate serves as a cathode to electrolytically etch a metal produced on a surface of the processing electrode.
